(19) United States
(12) Patent Application Publication
(10) Pub. No.: US 2023/0076981 A1
(43) Pub. Date: Mar. 9, 2023

(54) Method and system for an induction heating capable welder

(71) Applicants: Peter Skotte, San Diego, CA (US); Jakob Stafford, San Diego, CA (US)

(72) Inventors: Peter Skotte, San Diego, CA (US); Jakob Stafford, San Diego, CA (US)

(21) Appl. No.: 17/468,951

(22) Filed: Sep. 8, 2021

(51) Int. Cl. B23K 13/08; H05B 6/06; H02M 7/5387

(52) U.S. Cl. CPC B23K 13/08; H05B 6/06; H02M 7/5387

(57) ABSTRACT

The invention described herein generally pertains to a system and method related to a welding and induction heating system capable of providing an output suitable for induction heating using a welding device. The welding device is configured to output a welding current at at least one welding frequency. The switching device present in welding machines utilizing technology including, but not limited to, insulated-gate bipolar transistor inverters, zero voltage switching, full bridge inverters, half bridge inverters, and quarter bridge inverters are capable of generating an output frequency that has the capability to produce induction heating. A switching device in communication with the welding device is capable of increasing the at least one welding frequency to output an induction heating current at at least one induction heating frequency.

### SUMMARY OF THE INVENTION

In accordance with an embodiment of the present invention, a welding and induction heating system is provided that includes a welding device configured to output a welding current at at least one welding frequency. The system can further include a switching device in communication with the welding device and capable of increasing the at least one welding frequency to output an induction heating current at at least one induction heating frequency.

In accordance with an embodiment of the present invention, a welding and induction heating system is provided including a welding device having at least one output terminal. The system can further include an induction heating enabling device in communication with at least one output of the welder to provide an induction heating current.

In accordance with an embodiment of the present invention, a method is provided that includes at least the steps of creating a welding current having a frequency and increasing the frequency of the welding current to enable the device to be utilized for induction heating.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates an exemplary, non-limiting embodiment of a welding and induction heating system that efficiently and economically provides for induction heating;

FIG. 2 illustrates an exemplary, non-limiting embodiment of a welding and induction heating system that utilizes a welder in combination with an external device;

FIG. 3 illustrates an exemplary, non-limiting embodiment of the external device of FIG. 2;

FIG. 4 illustrates a typical configuration of a welder of the prior art; and

FIG. 5. Illustrates an exemplary, non-limiting embodiment of a welding and induction heating system from modifying the prior art welder of FIG. 4.

### DETAILED DESCRIPTION OF THE INVENTION

Embodiments of the invention relate to methods and systems that relate to welding and induction heating using a welding device in combination with a switching device or using a welder in combination with a induction heating enabling device to provide induction heating current.

“Welding” or “weld” as used herein including any other formatives of these words will refer to depositing of molten material through the operation of an electric arc including but not limited to submerged arc welding, gas tungsten arc welding, gas metal arc welding, metal active welding, metal inert gas welding, tungsten inert gas welding, any high energy heat source (e.g., a laser, an electron beam, among others), or any electric arc used with a welding system.

While the embodiments discussed herein have been related to the systems and methods discussed above, these embodiments are intended to be exemplary and are not intended to limit the applicability of these embodiments to only those discussions set forth herein. The systems and methodologies discussed herein are equally applicable to, and can be utilized in, systems and methods related to induction annealing, induction bonding, induction brazing, carbide tip brazing, induction casting, induction end forming, induction crystal growing, induction coating and curing, induction forging and hot forming, induction hardening, induction shrink fitting, induction melting of metal, induction preheating and post heating, induction soldering, heat-staking, induction susceptor heating, identifying a metal type based on the heating characteristics of the material and induction wire heating, without departing from the spirit or scope of the above discussed inventions. The embodiments and discussions herein can be readily incorporated into any of these systems and methodologies by those of skill in the art. By way of example and not limitation, a welding device as used herein can be a device that performs welding, arc welding, laser welding, brazing, soldering, plasma cutting, 5t laser cutting, among others. Thus, one of sound engineering and judgment can choose devices other than a welding device without departing from the intended scope of coverage of the embodiments of the subject invention.

The welding device utilized in the present invention is configured to output a welding current and have the topography necessary to alter the output frequency. The welding device has an induction coil to permit performance of the tasks to be carried out by an induction heater. The induction coil is used to generate an electromagnetic field through the workpiece, generating heat through eddy currents, effectively and accurately heating the material to a desired temperature and depth. The application of the present invention would allow the welding device to be modified to accommodate both the welding and induction heating capabilities utilizing much of the same electrical components in existing welding machines at the time of this writing or include a switching device in communication with the welding device capable of increasing at least one welding frequency to output an induction heating current at at least one induction heating frequency.

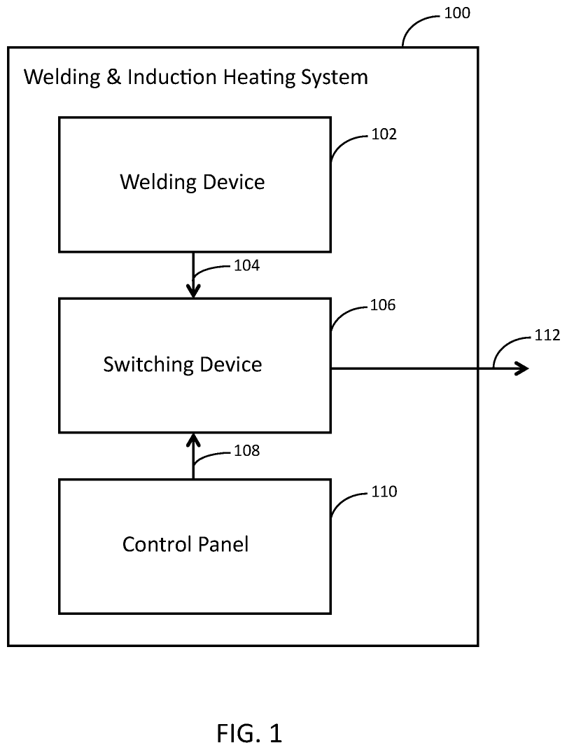

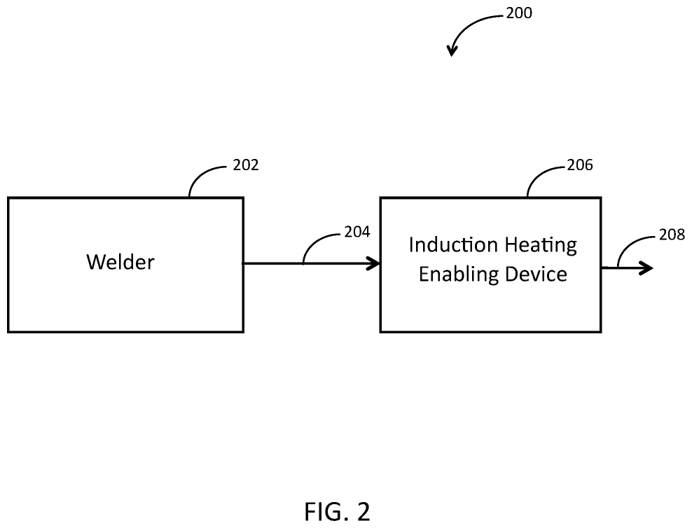

The best mode for carrying out the invention will now be described for the purposes of illustrating the best mode known to the applicant at the time of the filing of this patent application. The examples and figures are illustrative only and not meant to limit the invention, which is measured by the scope and spirit of the claims. Referring now to the drawings, wherein the showings are for the purpose of illustrating an exemplary embodiment of the invention only and not for the purpose of limiting same, FIG. 1 illustrates a welding and induction heating system as a modified manual welding device and FIG. 2 illustrates a welding and induction heating device using a manual welding device and a separate induction heating enabling device.

Turning to FIG. 1, an exemplary, non-limiting embodiment of a welding and induction heating system 100 is illustrated that provides induction heating capabilities in an efficient and economical manner. System 100 includes welding device 102 having at least one output 104 for providing an internal welding current. The welding device output 104 typically includes a positive terminal and a negative terminal. The internal welding current is typically provided at a frequency suitable for welding. System 100 can include a switching device 106 that is configured to receive output 104 and include a least one output 112 providing either induction heating current or output welding current. The switching device 106 may include one or more of the following: a zero voltage switching driver, a half bridge inverter, or a full bridge inverter. The induction heating current is provided at a frequency suitable for induction heating, such as in the range of 750 Hz to 800 kHz. The induction heating current frequency is variable. System 100 includes a control panel 110 having at least one output 108 suitable for commanding the switching device to provide the output welding current or the induction heating current to welding or induction heating devices. The control panel 110 can also variably control the frequency of the output welding current or induction heating current.

Turning to FIG. 2, an exemplary, non-limiting embodiment of a welding and induction heating system 200 is illustrated that provides induction heating capabilities using a standalone welder and an external device. System 200 includes welder 202 and an induction heating enabling device 206. The welder has at least one output 204 providing a welding current. The welder output 204 typically includes a positive terminal and a negative terminal. The welding current is provided at an adjustable frequency that is suitable for welding. The induction heating enabling device 206 receives the output 204 and has at least one output 208 providing an induction heating current. The switching device 206 may include one or more of the following: a zero voltage switching driver, a half bridge inverter, or a full bridge inverter. The induction heating current is provided at a frequency suitable for induction heating, such as in the range of 750 Hz to 800 kHz. The induction heating current frequency is variable.

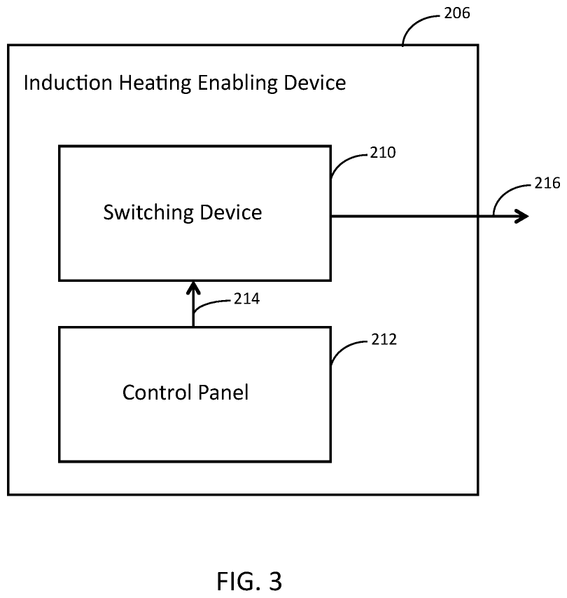

The induction heating enabling device 206 as shown in FIG. 3 includes a switching device 210 and a control panel 212. The switching device 210 receives at least one control signal 214 for controlling the output 216 providing the induction heating current. The control panel 210 can also variably control the frequency of the welding or induction heating current.

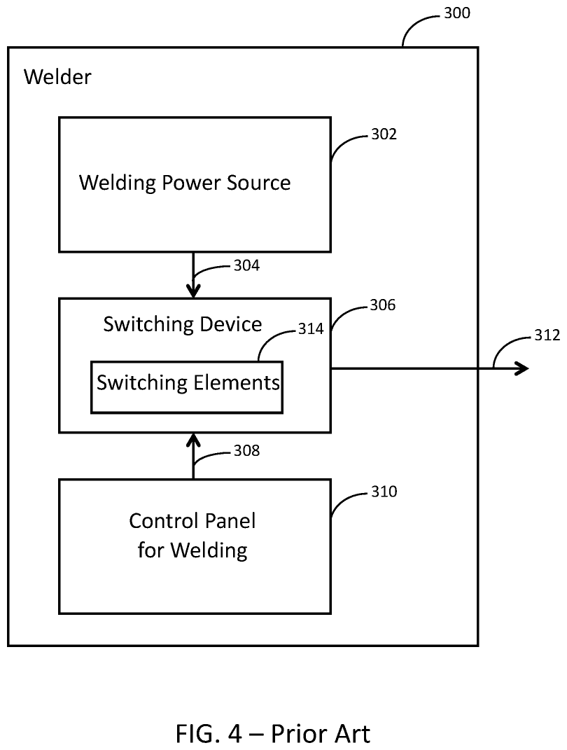

Turning to FIG. 4, an embodiment of a typical prior art welder 300 is illustrated that provides induction heating capabilities. System 300 includes welding power source 302 having at least one output 304 for providing an internal welding current. The welding device output 304 typically includes a positive terminal and a negative terminal. The internal welding current is typically provided at a frequency suitable for welding. System 300 can include a switching device 306 that is configured to receive output 304 and include a least one output 312 providing an output welding current. The switching device 306 may include one or more of the following: a zero voltage switching driver, a half bridge inverter, or a full bridge inverter. The output welding current is provided at a frequency suitable for welding, such as less than 500 Hz. The output welding current frequency may be variable. System 300 includes a control panel 310 having at least one output 308 suitable for commanding the switching device to provide the output welding current to welding devices. The control panel 310 can also variably control the frequency of the output welding current.

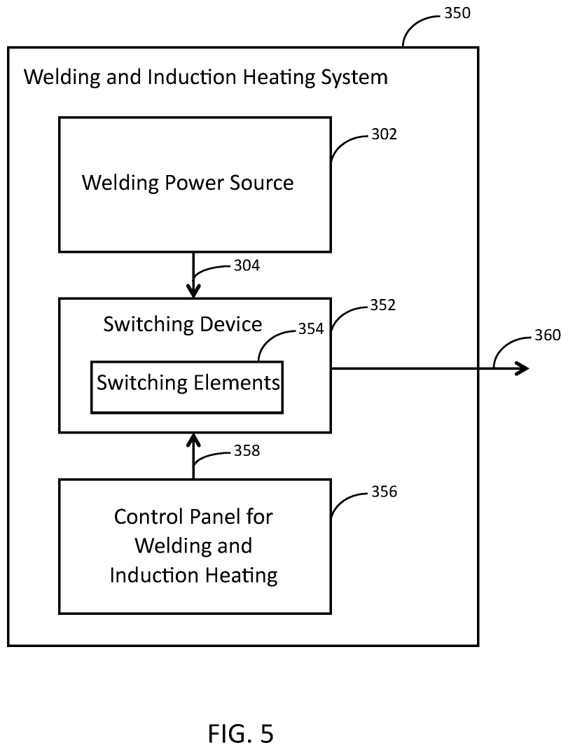

Turning to FIG. 5, an exemplary, non-limiting embodiment of a welding and induction heating system 350 from modifying prior art welder 300 of FIG. 4 is illustrated that provides induction heating capabilities in an efficient and economical manner. System 350 includes welding device 302 having at least one output 304 for providing an internal welding current. The welding device output 304 typically includes a positive terminal and a negative terminal. The internal welding current is typically provided at a frequency suitable for welding. System 350 can include a switching device 352 that is configured to receive output 304 and include a least one output 360 providing either induction heating current or output welding current. The switching device 352 includes switching element 354 that may include one or more of the following: a zero voltage switching driver, a half bridge inverter, or a full bridge inverter. The induction heating current is provided at a frequency suitable for induction heating, such as in the range of 750 Hz to 800 kHz. The induction heating current frequency is variable. System 350 includes a control panel 356 having at least one output 358 suitable for commanding the switching device to provide the output welding current or the induction heating current to welding or induction heating devices. The control panel 356 can also variably control the frequency of the output welding current or induction heating current.

An exemplary, non-limiting embodiment of a method of induction heating using a welder comprises the steps of modifying a switching device of the welder to creating an output current having a frequency for induction heating and modifying a control panel of the welder to allow control of the frequency of the output current making the welder suitable for both welding and induction heating. The modifying of the switching device may comprise replacing at least one original switching element to a new switching element capable of increasing the frequency of the output current suitable to at least one induction heating frequency and/or software changes, which may include additions, subtractions, or modifications, of the switching device that allow for at least one induction heating frequency. The new switching device may be one or more of the following: a zero voltage switching driver, a half bridge inverter, or a full bridge inverter. The induction heating frequency is variable and in the range of 750 Hz to 800 kHz.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A welding and induction heating system, comprising:
a welding device configured to output a welding current at at least one welding frequency.
a switching device in communication with the welding device and capable of increasing the at least one welding frequency to output an induction heating current at at least one induction heating frequency; and
at least one output capable of providing the welding current or the induction heating current.

2. The welding and induction heating system of claim 1, wherein the switching device utilizes at least one zero voltage switching drivers.

3. The welding and induction heating system of claim 1, wherein the switching device utilizes at least one half bridge inverter.

4. The welding and induction heating system of claim 1, wherein the switching device utilizes at least one full bridge inverter.

5. The welding and induction heating system of claim 1, wherein the at least one induction heating frequency is in the range of 750 hz to 800 kHz.

6. The welding and induction heating system of claim 1, wherein the at least one induction heating frequency is variable.

7. The welding and induction heating system of claim 1, further including a control panel capable of adjusting the at least one output frequency.

8. A welding and induction heating system, comprising:
a welder having at least one welding output; and
an induction heating enabling device in communication with the at least one induction heating output of the welder capable of outputting an induction heating current at at least one induction heating frequency.

9. The welding and induction heating system of claim 8, wherein the induction heating enabling device includes a switching device and a control panel.

10. The welding and induction heating system of claim 9, wherein the switching device utilizes at least one zero voltage switching drivers.

11. The welding and induction heating system of claim 9, wherein the switching device utilizes at least one half bridge inverter.

12. The welding and induction heating system of claim 9, wherein the switching device utilizes at least one full bridge inverter.

13. The welding and induction heating system of claim 9, wherein the at least one induction heating frequency is in the range of 750 Hz to 800 kHz.

14. The welding and induction heating system of claim 9, wherein the at least one induction heating frequency is variable.

15. The welding and induction heating system of claim 9, including a control panel capable of adjusting the at least one induction heating output.

16. A method of induction heating using a welder comprising the steps of:
modifying a switching device of the welder to creating an output current having a frequency for induction heating and
modifying a control panel of the welder to allow control of the frequency of the output current making the welder suitable for both welding and induction heating.

17. The method of claim 16, wherein the modifying of the switching device comprises replacing at least one original switching element to a new switching element capable of increasing the frequency of the output current suitable to at least one induction heating frequency

18. The method of claim 17, wherein the at least one induction heating frequency is in the range of 750 Hz to 800 kHz.

19. The method of claim 16, wherein the modifying of the switching device comprises software changes of the switching device that allow for at least one induction heating frequency.

20. The method of claim 19, wherein the at least one induction heating frequency is in the range of 750 Hz to 800 kHz.
